(19) United States
(12) Patent Application Publication
(10) Pub. No.: US 2006/0157897 A1
(43) Pub. Date: Jul. 20, 2006

(54) Molding method of plastic materials

(75) Inventors: Fumiyuki Suzuki, Odawara (JP); Tadashi Mochizuki, Odawara (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/319,502

(22) Filed: Dec. 29, 2005

(30) Foreign Application Priority Data
Jan. 18, 2005 (JP) 2005-010398
Apr. 15, 2005 (JP) 2005-118211

(51) Int. Cl. B29D 11/00

(52) U.S. Cl. 264/492; 264/481; 264/1.32; 264/1.36

(57) ABSTRACT

A plastic molding method comprising steps of heating a plastic material with irradiation of infrared laser or focused infrared to the plastic material put in a cavity of a molding die and compressing the plastic material within the cavity for deforming the plastic material into a given shape. The plastic material is a transparent material to visible light to which an infrared absorption material is added. The infrared laser is irradiated using a carbon dioxide gas laser unit. A water content of the plastic material is no more than 0.01% by mass. The irradiation of the infrared to the plastic material is implemented under atmosphere of an inert gas. The plastic material is any one of polycarbonate, polyester, cyclopolyolefin, acryl, alicyclic acryl resin, and olefin-maleimide-alternating-copolymer. Accordingly, the plastic material can be effectively heated up by the infrared within a short time, thereby resulting in increasing a manufacturing efficiency of products.

### CROSS REFERENCE TO RELATED APPLICATIONS

This application claims the foreign priority benefit under Title 35, United States Code, §119(a)-(d) of Japanese Patent Applications No. 2005-010398 and 2005-118211, filed on Jan. 18, 2005 and Apr. 15, 2005, respectively, the contents of which are hereby incorporated by reference.

### BACKGROUND OF THE INVENTION

1. Technical Field of the Invention

The present invention relates to a molding method of a plastic material for manufacturing a product with compression molding of the plastic material.

2. Description of the Related Art

As a manufacturing method of a plastic lens using a plastic material, there is a method where the plastic lens is manufactured with compression molding of the plastic material within a cavity formed between each main die of a molding die by combining the each main die, that is, an upper main die and a lower main die arranged in upper and in lower positions, respectively.

Here, in compression molding of a plastic material, when the plastic material is manufactured at a temperature equal to or less than a glass-transition temperature, a large distortion is remained within the plastic material after the compression molding. Then, it is necessary to heat up the plastic material to a temperature equal to or more than the glass-transition temperature to soften the plastic material before compression molding. Therefore, after putting the plastic material in the lower main die, the plastic material is heated with an irradiation of infrared toward the lower main die by inserting an infrared panel heater between the each main die. For example, Japanese Laid-Open Patent Application No. 7-148857 (paragraph [0009], and FIG. 2) discloses the above method.

When a plastic material is heated with infrared like the above, only the plastic material can be heated up without heating the main die.

Meanwhile, the plastic material is taken out from the cavity after cooling the material to a temperature equal to or less than the glass-transition temperature for hardening for preventing the softened plastic material from being deformed when the material is taken out from the main die after compression molding. In the manufacturing method described in the above, since the main die is not heated, cooling of the plastic material within a short time can be achieved in the cavity.

However, in the above manufacturing method, since the infrared is diffusely irradiated from the infrared panel heater, it is difficult to narrow an irradiation area of the infrared. As a result, the infrared is also irradiated on an area other than the plastic material when a small product, for example, a plastic lens with a diameter equal to or less than 10 mm is manufactured. As understood from the above, since a heating efficiency of the infrared panel heater is low, a heating time of the plastic material becomes long.

It is therefore requested to the present invention to provide a molding method of aplastic material, in which the aforementioned issues can be solved, a plastic material can be heated up effectively with infrared within a short time, and as a result, a manufacturing efficiency of a product can be improved.

### SUMMARY OF THE INVENTION

To solve the aforementioned issues, according to a first aspect of the present invention, there is provided a plastic molding method, comprising steps of: heating a plastic material with irradiation of one of infrared laser and focused infrared to the plastic material put in a cavity of a molding die; and compressing the plastic material within the cavity for deforming the plastic material into a given shape.

Here, the plastic material is not limited to, but selected by considering a manufacturing product.

In addition, a kind of the infrared is not limited to, but can be used any one of near-infrared (wavelength: about 0.7 μm to 1.4 μm), middle-infrared (wavelength: about 1.4 μm to 3 μm), and far-infrared (wavelength: about 3 μm to 100 μm).

Further, the laser is an infrared beam irradiating a small area. Therefore, it is preferable to use the infrared beam for irradiating an area of around 5 mm to 10 mm in diameter. A method for irradiating the laser is not limited to, but, for example, a method which irradiates laser through focusing, using a reflection mirror and the like, and a method irradiating the laser without focusing are both available for irradiating the laser.

Furthermore, a method for focusing infrared is not limited to, for example, a halogen lamp and the like as a light source can be focused, using a reflection mirror, a lens, and the like.

As described above, in the plastic molding method of the present invention, laser or focused infrared is irradiated to the plastic material. An irradiation area of the infrared can easily be controlled since the infrared is not diffused. Through this process, since the infrared can be accurately irradiated to the plastic material, the plastic material can be effectively heated up with the infrared within a short time.

According to a second aspect of the present invention, there is provided a plastic molding method, wherein the plastic material is a transparent material to visible light to which an infrared absorption material is added.

Here, the infrared absorption material is a material for generating heat by absorbing the irradiated infrared. A ready-made pigment or dye may be used for the infrared absorption material. Addition amount of the absorption material is not limited if the plastic material, to which the absorption material is added, is substantially transparent to visible light.

As with the aforementioned, in the plastic molding method of the present invention, the plastic material is composed of a transparent material to visible light to which the infrared absorption material is added. Therefore, even if a transparent material, which is not able to be heated up with near-infrared and middle-infrared as it is, can be heated up with the near-infrared and the middle-infrared. Then, by adjusting the addition amount of the infrared absorption material, a plastic material having very little absorbance to visible light due to the added infrared absorption material can be prepared. As a result, a substantially transparent material to the visible light can be effectively heated up with the near-infrared and the middle-infrared within a short time.

Meanwhile, since the infrared absorption material is added to the plastic material, a plastic lens having an infrared-cut function is naturally produced if the plastic lens is manufactured using this plastic material with compression molding.

According to a third aspect of the present invention, there is provided a plastic molding method, wherein the infrared laser is irradiated using a carbon dioxide gas laser unit.

In the plastic molding method of the present invention, a heating efficiency of the plastic material can be increased since a high power laser can be irradiated using a carbon dioxide gas laser unit.

According to a fourth aspect of the present invention, there is provided a plastic molding method, wherein a water content of the plastic material is no more than 0.01% by mass.

According to a fifth aspect of the present invention, there is provided a plastic molding method, wherein a water content of the plastic material is reduced to no more than 0.01% by mass in advance before heating the plastic material.

Here, when the plastic material is rapidly heated up, air foams may be generated within the plastic material after heating due to vaporization of a liquid, for example, water and the like within the plastic material without diffusing outside of the material.

Then, according to the plastic molding method of the present invention, by reducing the water content within the plastic material no more than 0.01% in mass, generation of the air foams can be suppressed even if the plastic material is rapidly heated up, since the liquid content within the plastic material is small. With the above condition, high power laser or focused infrared can be irradiated to the plastic material for rapidly heating the material, thereby resulting in increasing of the heating efficiency.

According to a sixth aspect of the present invention, there is provided a plastic molding method, wherein the irradiation of the infrared laser or the focused infrared to the plastic material is implemented under an atmosphere of an inert gas.

Here, when the plastic material is irradiated with the high power laser or the focused infrared, a highly heated surface of the plastic material may be oxidized with oxygen in the air surrounding the plastic material, that is, the surface may be colored by baking.

According to the plastic molding method of the present invention, the highly heated surface of the plastic material can be prevented from oxidizing with irradiation of the laser or the focused infrared to the plastic material under the atmosphere of the inert gas. Through this, the high power laser or the focused infrared can be irradiated to the plastic material for rapidly heating the material, thereby resulting in increasing of the heating efficiency of the plastic material.

According to a seventh aspect of the present invention, there is provided a plastic molding method, wherein the inert gas is one selected from a group of carbon dioxide, nitrogen, argon, helium, and a combination of the inert gas.

Since an inert gas atmosphere is composed of any one of carbon dioxide, nitrogen, argon, helium, and a combination of the inert gas, a heated plastic material can be prevented from oxidizing.

According to an eighth aspect of the present invention, there is provided a plastic molding method, wherein the plastic material is any one selected from a group of polycarbonate, polyester, cyclopolyolefin, acryl, alicyclic acryl resin, and olefin-maleimide-alternating-copolymer.

According to the plastic molding method of the present invention, since the plastic material is configured with polycarbonate, polyester, cyclopolyolefin, acryl, alicyclic acryl resin, and olefin-maleimide-alternating-copolymer, a plastic material having a good transparency to visible light and also applicable to an optical product can be effectively heated up with infrared.

According to the plastic molding method described in the above, the laser or the focused infrared can be accurately irradiated to the plastic material by easily controlling the infrared irradiation area. As a result, the plastic material can be efficiently heated up by the laser or the focused infrared within a short time, thereby resulting in increasing a manufacturing efficiency of products.

### BRIEF DESCRIPTION OF THE DRAWINGS

The aspects of the present invention will become more apparent by describing in detail illustrative, non-limiting embodiments thereof with reference to the accompanying drawings, in which:

FIG. 1A is a side cross sectional view showing each main die being separated to each other of a molding die for a molding method of a plastic material of an embodiment of the present invention;

FIG. 1B is a side cross sectional view showing each main die being engaged with each other of a molding die for a molding method of plastic material of the embodiment;

FIG. 2A is a plane view showing an upper main die of a molding die for a molding method of plastic material of the embodiment;

FIG. 2B is a plane view showing a lower main die of a molding die for a molding method of plastic material of the embodiment;

FIG. 3 is a side cross sectional view showing a molding die, in which a light focusing unit is arranged between main dies of the molding die, for a molding method of plastic material of the embodiment;

FIG. 4A is a side cross sectional view showing a status where a plastic material is put in a lower main die of a molding die for a molding method of plastic material of the embodiment;

FIG. 4B is a side cross sectional view showing a status where a laser beam is irradiated on a plastic material in a molding method of plastic material in the embodiment;

FIG. 5A is a side cross sectional view showing a status where an upper main die is lowered toward a lower main die of a molding die for a molding method of plastic material in the embodiment;

FIG. 5B is a side cross sectional view showing a status where the upper main die and the lower main die are combined to each other in a molding method of plastic material in the embodiment; and

FIG. 6 is a table comparing generation of air foams by each plastic material containing different water content after heating in a molding method of plastic material according to the embodiment.

### DESCRIPTION OF THE PREFFERED EMBODIMENTS

Next, embodiment of the present invention will be explained in detail by referring to figures.

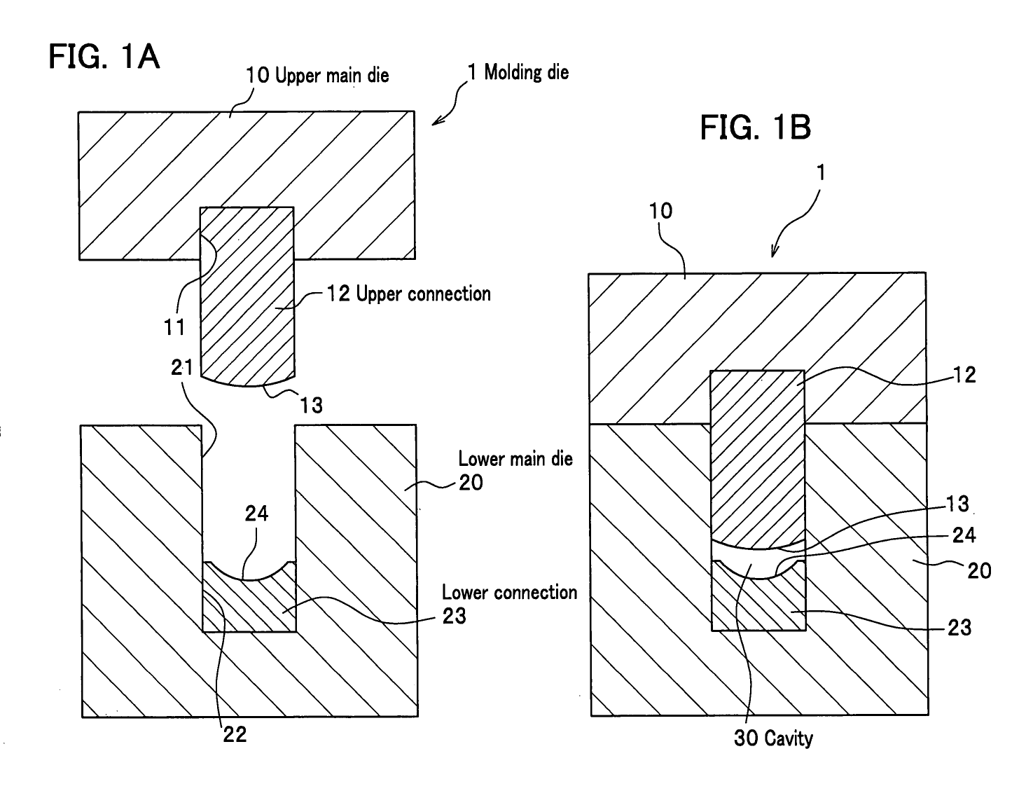

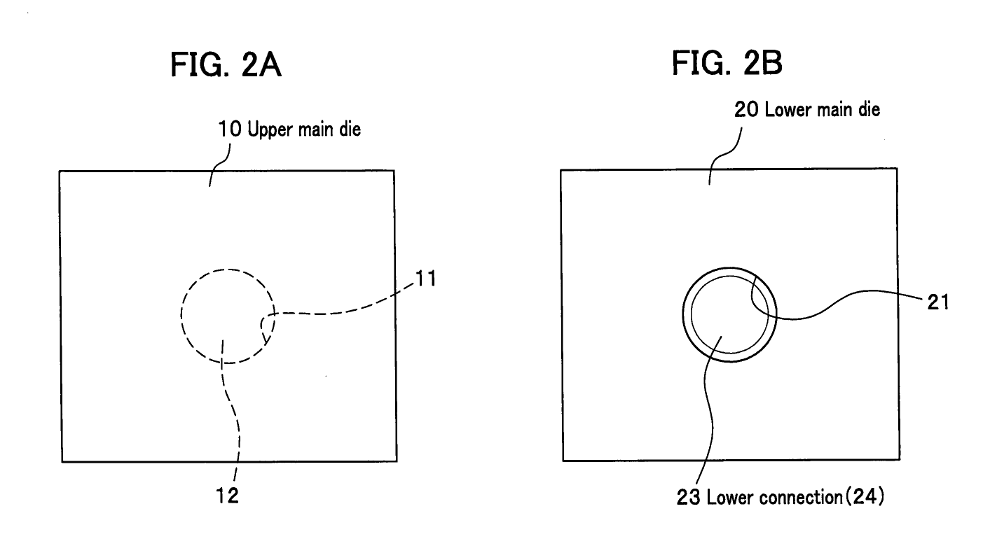

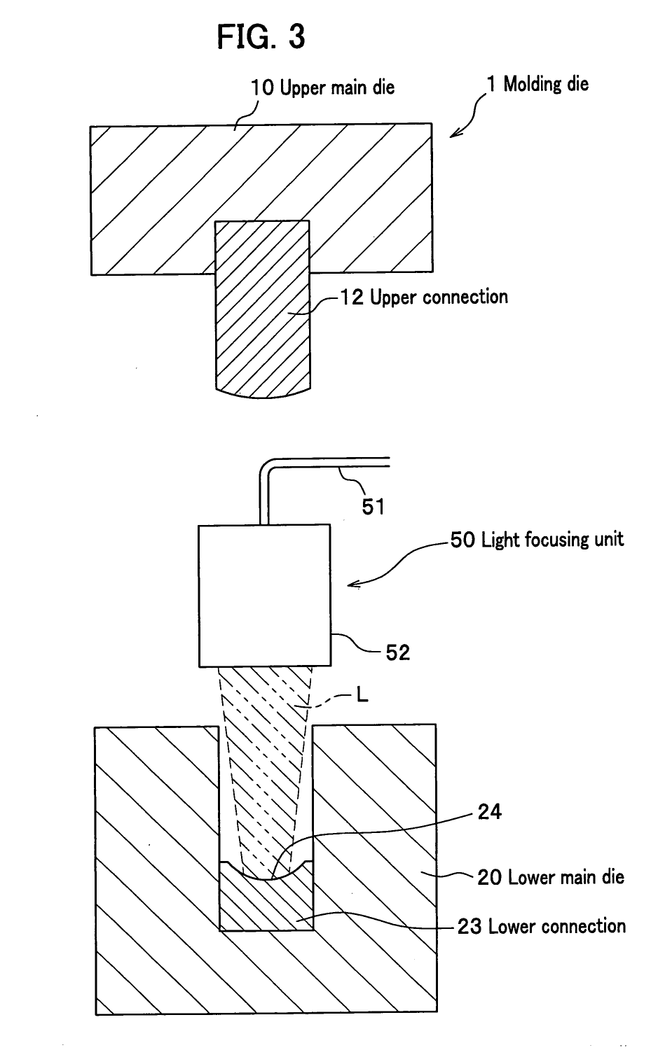

FIGS. 1A and 1B are views showing a molding die for a molding method of plastic material of the present embodiment. FIG. 1A is a side cross sectional view showing each main die being separated, and FIG. 1B is a side cross sectional view showing the each main die being engaged with. FIGS. 2A and 2B are views showing a molding die for a molding method of plastic material of the present embodiment. FIG. 2A is a plane view showing an upper main die, and FIG. 2B is a plane view showing a lower main die. FIG. 3 is a side cross sectional view showing a molding die, in which a light focusing unit is arranged between the main dies, for a molding method of plastic material of the embodiment.

In the present embodiment, an example for manufacturing a plastic lens with compression molding of a plastic material will be used for explaining the present invention.

(Configuration of Molding Die)

Molding die 1 is configured, as shown in FIGS. 1A and 1B, so that a plastic material put in a space of cavity 30, which is formed between an upper main die 10 and a lower main die 20, is processed with compression molding by combining upper main die 10 and lower main die 20 arranged in upper and lower positions, respectively.

(Configuration of Upper Main Die)

Upper main die 10 is, as shown in FIG. 1A and FIG. 2A, a rectangular solid made of steel, and has concave portion 11 with a circular cross section at a center of a bottom surface.

An upper end of upper connection 12, which is a circular cylinder made of steel, is engaged with concave portion 11 of upper main die 10. That is, upper connection 12 is protruded downward from a bottom surface of upper main die 10.

Bottom end surface 13 of upper connection 12 is a molding portion for molding a concave optical surface, and has a convex bowing surface, for example, a spherical surface and the like which correspond to a curvature of the concave optical surface.

(Configuration of Lower Main Die)

Lower main die 20 is, as shown in FIG. 1A and FIG. 2B, a rectangular solid made of steel, and therein is provided inserting hole 21 with a circular cross-section at a center of an upper surface of lower main die 20. Inserting hole 21 has a diameter little larger than a diameter of upper connection 12 of upper main die 10 so as to be able to insert upper connection 12 into the hole.

Lower connection 23, which is a circular cylinder made of steel, is engaged with lower portion 22 of inserting hole 21. That is, a bottom surface of lower connection 23 is contacted to a bottom of inserting hole 21.

Upper end surface 24 of lower connection 23 is a molding portion for molding a convex optical surface, and has a concave bowing surface, for example, a spherical surface and the like which correspond to a curvature of the convex optical surface.

A depth of inserting hole 21 is deeper than a protruded distance of upper connection 12 so as to form a space between bottom end surface 13 of upper connection 12 and upper end surface 24 of lower connection 23 when upper connection 12 is inserted into inserting hole 21 (refer to FIG. 1B).

(Configuration of Cavity)

Cavity 30 is, as shown in FIG. 1B, a space for processing a plastic material with compression molding. That is, cavity 30 is a space formed between bottom end surface 13 of upper connection 12 and upper end surface 24 of lower connection 23 when upper main die 10 and lower main die 20 are combined by inserting upper connection 12 of upper main die 10 into inserting hole 21 of lower main die 20. Namely, an upper inner surface of cavity 30 is configured with bottom end surface 13 of upper connection 12, and a lower inner surface of cavity 30 is configured with upper end surface 24 of lower connection 23.

(Configuration of Light Focusing Unit)

Light focusing unit 50 has, as shown in FIG. 3, a light source of a common semiconductor laser unit (not shown) radiating near-infrared laser, and is configured so that the near-infrared laser radiated from the light source is transmitted to irradiation unit 52 through optical fiber 51 and radiated downward from irradiation unit 52 by focusing laser L through a lens set in irradiation unit 52.

And, laser L can be irradiated on upper end surface 24 of lower connection 23 of lower main die 20 by inserting irradiation unit 52 between main dies 10 and 20 when upper main die 10 and lower main die are separated.

Meanwhile, it is preferable that the semiconductor laser unit as a light source of light focusing unit 50 radiates light of which oscillation wavelength is 808 nm or 940 nm, considering handling easiness.

In addition, light focusing unit 50 is configured so that a center of irradiation area of laser L corresponds to a center of upper end surface 24 of lower connection 23, and also configured so that the irradiation area corresponds to a projection area of a plastic material for molding. The irradiation area in the embodiment is set in a circular area with a diameter of 10 mm.

In the light focusing unit 50, since laser L of near-infrared laser is irradiated through focusing, thereby the near-infrared laser is not diffused, it is possible to irradiate the laser on the plastic material having a small diameter by controlling the radiation area of laser L with ease.

(Molding Method of Plastic Material)

Next, a manufacturing of a plastic lens using a molding method of a plastic material in this embodiment will be explained.

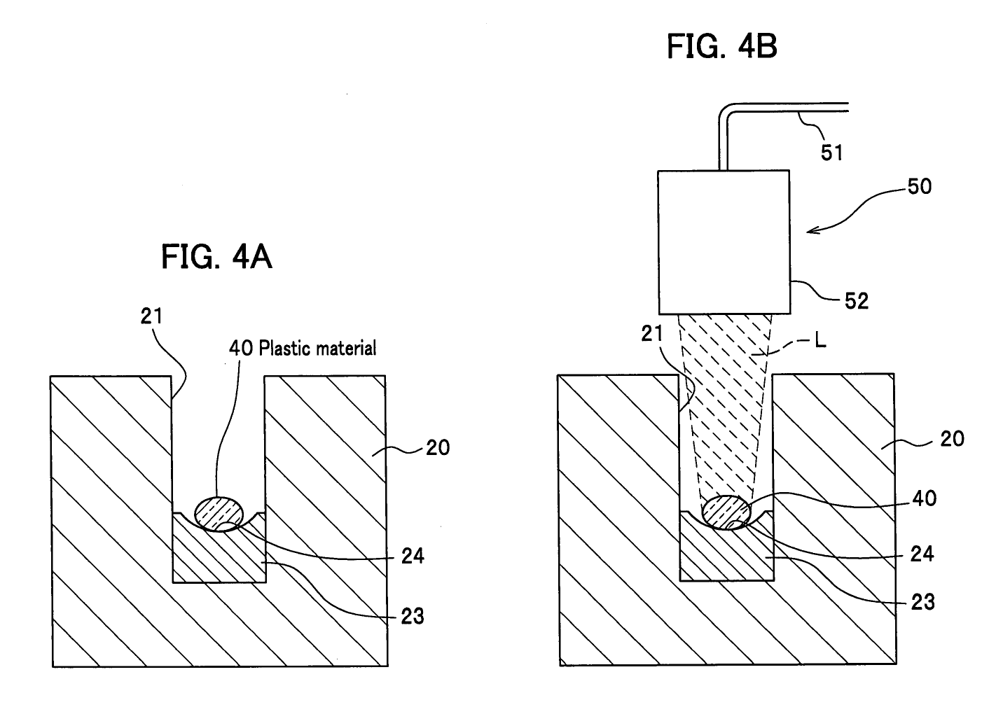

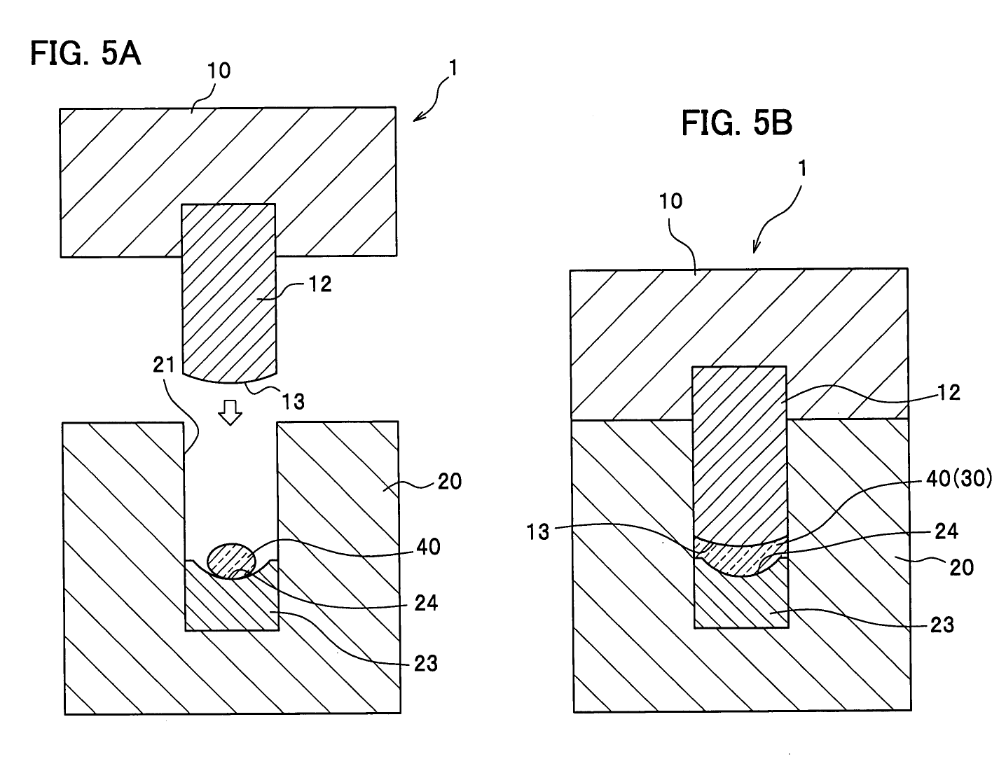

FIGS. 4A and 4B are views showing a molding method of a plastic material in the embodiment. FIG. 4A is a side cross sectional view showing a status where the plastic material is put in a lower main die, and FIG. 4B is a side cross sectional view showing a status where a laser beam is irradiated on the plastic material. FIGS. 5A and 5B are views showing the molding method of the plastic material in the embodiment. FIG. 5A is a side cross sectional view showing a status where an upper main die is lowered toward the lower main die, and FIG. 5B is a side cross sectional view showing a status where the upper main die and the lower main die are combined to each other.

In the embodiment, as an example, a manufacturing of a plastic lens using a plastic material of polycarbonate mixed with an infrared absorption material will be explained.

The infrared absorption material is not limited, but available if it is a dye, or a pigment which can generate heat by absorbing infrared. However, a small absorption of visible light is preferable. For example, a pigment having fine particles and good transparency to visible light when the pigment is added to the plastic material is preferable. In the present embodiment, a material having a high absorption coefficient of infrared, which is radiated from light focusing unit 50 (refer to FIG. 3) as laser, is arbitrarily selected from, for example, a group of cyanine, phthalocyanine, naphthalocyanine, merocyanine, rhodacyanine, styryl, and base styryl, considering a wavelength of the infrared used for heat generation. For example, the pigment is selected from SDA series manufactured by H. W. SANDS CORP. based on consideration of the oscillation frequency of the infrared, and the pigment is added to the plastic material, of which amount is limited so that the plastic material is substantially transparent to the visible light.

Meanwhile, when radiated infrared is far-infrared, since the plastic material can absorb the far-infrared by itself, it is not necessary to add an infrared absorbing material. In addition, even if the radiated infrared is near-infrared or middle-infrared, it is not necessary to add the infrared absorption material to the plastic material in some cases if a halogen lamp is used as a light source.

As a method for adding the infrared absorption material to the plastic material, for example, a method of polymerizing by adding the infrared absorption material to a raw plastic material, and a method of melting and mixing up of the raw plastic material and the infrared absorption material can be employed.

Next, a process for manufacturing a plastic lens using the plastic material will be specifically explained.

First, as shown in FIG. 1A, upper main die 10 and lower main die 20 are separated upward and downward, to each other. Then, as shown in FIG. 4A, plastic material 40 is put in inserting hole 21 of lower main die 20 and placed on upper end surface 24 of lower connection 23.

After that, as shown in FIG. 4B, by inserting irradiation unit 52 of light focusing unit 50 above lower main die 20, laser L is radiated from irradiation unit 52 on plastic material 40 in inserting hole 21, while a center of irradiation area of laser L radiated from irradiation unit 52 corresponds to a center of upper end surface 24 of lower connection 23.

Like the above, with irradiation of laser L of near-infrared through focusing, the infrared absorption material added to plastic material 40 generates heat due to absorption of the near-infrared, thereby resulting in heating of plastic material 40.

Since laser L of near-infrared is accurately irradiated on plastic material 40, it is possible to effectively heat plastic material 40 by the near-infrared within a short time.

Meanwhile, lower main die 20 is not heated by the irradiation of the near-infrared, and only plastic material 40 is heated.

Then, as shown in FIG. 5A, upper main die 10 is lowered against lower main die 20 after softening plastic material 40 by heating the material equal to or more than a glass-transition temperature, to insert upper connection 12 of upper main die 10 into inserting hole 21 of lower main die 20 for combining upper main die 10 and lower main die 20.

Through the above process, as shown in FIG. 5B, plastic material 40 is put in cavity 30 which is formed between bottom end surface 13 of upper connection 12 and upper end surface 24 of lower connection 23, and pressed with upper connection 12. As a result, plastic material 40 reaches to saturation within cavity 30 through deformation.

Here, bottom end surface 13 of upper connection 12 corresponds to a shape of a concave optical surface, and also upper end surface 24 of lower connection 23 corresponds to a shape of a convex optical surface. Therefore, plastic material 40 saturated within cavity 30 has a thickness corresponding to a distance between bottom end surface 13 of upper connection 12 and upper end surface 24 of lower connection 23. As a result, a plastic lens which has concave and convex optical surfaces is formed.

After compression molding of plastic material 40, plastic material 40 is cooled for hardening to a temperature lower than a glass-transition temperature within cavity 30 for preventing plastic material 40 from being deformed when it is taken out from molding die 1. When plastic material 40 is heated with laser L (refer to FIG. 4B), only plastic material 40 is heated and molding die 1 is not heated. Therefore, it is possible to cut a cooling time for molding die 1, thereby resulting in a short cooling time of plastic material 40.

After cooling plastic material 40 within cavity 30, upper main die 10 and lower main die 20 are separated, and plastic material 40 is taken out from lower main die 20. Then, a plastic lens is completed after working upon a periphery of plastic material 40.

Meanwhile, the plastic lens manufactured with the molding method of plastic material according to the present embodiment has been manufactured, using a plastic material where an infrared absorption material is added, while having substantially transparency to visible light. Therefore, the plastic lens essentially has a function of cutting infrared.

Here, a CCD (Charge-Coupled Device) camera (includes a still camera and a video camera) is configured with a combination of a plastic lens and an infrared-cut filter for preventing infrared from entering. However, by giving an infrared-cut function to the plastic lens itself like the lens manufactured with the present embodiment, it becomes unnecessary to install the infrared-cut filter, thereby resulting in simplification of the camera.

As described in the above, according to a molding method of a plastic material of the embodiment, it is able to efficiently heat up plastic material 40 within a short time without heating molding die 1 by accurately irradiating laser L of near-infrared on plastic material 40. As a result, it is also possible to cool plastic material 40 within a short time after the compression molding of plastic material 40. With the above process, since the heating, the cooling, and the compression molding of plastic material 40 can be implemented within a very short time, it is possible to increase a production efficiency of the plastic lens when plastic material 40 is continuously processed using molding die 1.

The embodiment of the present invention has been explained. However, the present invention is not limited to the embodiment described in the above. In the embodiment, as shown in FIG. 4A, plastic material 40 is irradiated with near-infrared laser using light focusing unit 50 which uses a semiconductor laser unit as a light source. The light source of light focusing unit 50 is not limited to the near-infrared laser. For example, YAG (Yttrium-Aluminum-Garnet) laser can also be used. Meanwhile, in the present embodiment, laser L is irradiated through focusing. However, if laser can precisely be irradiated to plastic material 40, the laser may be irradiated without focusing, and with plastic material 40 being out of focus.

In addition, middle-infrared and far-infrared may be used as the infrared. For example, a carbon dioxide gas laser may be used for a unit radiating far-infrared as a light source. If a high power far-infrared laser is irradiated using a carbon dioxide gas laser unit as a light source, it is possible to increase a heating efficiency of plastic material 40. Meanwhile, in a configuration where the carbon dioxide gas laser is used as a light source, it is preferable to transmit the far-infrared laser radiated from the light source with a hollow fiber.

Further, infrared from a halogen lamp or a carbon heater may be used by focusing with a reflection lens. When the halogen lamp is used, it is favorable to put the halogen lamp in light focusing unit 50 without transmitting the infrared through the optical fiber or the follow fiber.

Furthermore, in the embodiment, plastic material 40 is composed of polycarbonate. However, for example, by using polyester, cyclopolyolefin, acryl, alicyclic acryl resin, and olefin-maleimide-alternating-copolymer other than the polycarbonate, it is possible to efficiently heat plastic material 40, which is highly transparent to visible light and applicable to optical products.

A water content of plastic material 40 is controlled to a content equal to or less than 0.01% by mass. By reducing a liquid content of plastic material 40, it is possible to suppress generation of foams due to vaporization of the liquid such as water in plastic material 40 when plastic material 40 is rapidly heated. With the above condition, it is possible to irradiate high power laser L or high power focused infrared for rapid heating of plastic material 40. As a result, the improvement of the heating efficiency can be achieved.

Plastic material 40 of which water content is adjusted in advance to a content equal to or less than 0.01% by mass may be used. Also, it may be possible to control the water content of plastic material 40 to a content equal to or less than 0.01% by mass before heating plastic material 40. If the water content is controlled before a heating step, it is preferable that the water content is adjusted with drying before putting plastic material 40 in molding die 1. Regarding the drying conditions, a desired water content may be obtained by drying 0.1 to 10 hours at a temperature substantially higher than a glass-transition temperature and lower than a melting point or a flow-starting temperature. Further, the drying temperature may be a room temperature, and the drying atmosphere may be vacuum.

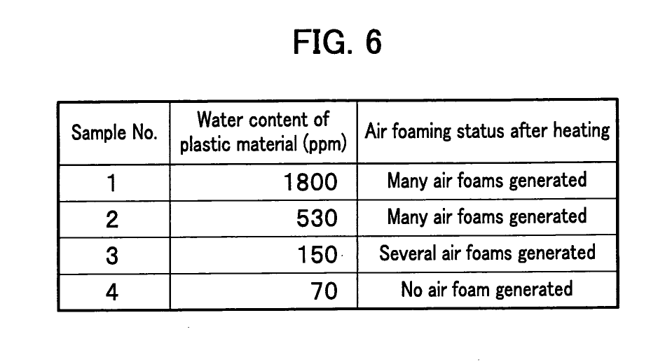

Here, as shown in FIG. 6, four examples of plastic material 40 containing four kinds of water content (1800 ppm, 530 ppm, 150 ppm, 70 ppm) have been prepared, using polycarbonate as a raw material, and laser from the carbon dioxide gas laser unit has been irradiated on each sample of plastic material 40 with 5 W/cm² for 15 seconds. Meanwhile, sample No. 1 in FIG. 6 is a non-dried plastic material 40. Samples No. 2 to 4 are plastic materials 40 dried at 120° C. in vacuum for each given time. As a result, in sample No. 4 containing the lowest water content (70 ppm, that is, 0.007% by mass) has not been generated any foam in plastic material 40 after the heating.

If plastic material 40 is irradiated by laser L or focused infrared in an atmosphere of one of inert gas or a combination of the inert gases selected from a group of carbon dioxide, nitrogen, argon, and helium, plastic material 40 can be prevented from a surface oxidation by the high temperature heating, that is, plastic material 40 can be prevented from a coloring by baking of the material. Under these conditions, it is possible to irradiate the high power laser L or the high power focused infrared on plastic material 40 to rapidly heat plastic material 40, thereby resulting in improvement of the heating efficiency.

As a configuration of a unit for treating plastic material 40 in an inert gas atmosphere, there are following units, for example, a unit where an inert gas from a nozzle attached to light focusing unit 50 is blown to plastic material 40, and a unit where plastic material 40 is placed in a closed space such as a chamber and the like filled with the inert gas.

Meanwhile, it is preferable that an oxygen concentration in an inert gas atmosphere is equal to or less than 10%, more favorably equal to or less than 5%, and most preferably equal to or less than 1%. In the unit blowing an inert gas from a blowing nozzle, the low oxygen concentrations can be achieved by increasing a blowing speed of the inert gas and by setting the blowing nozzle close to plastic material 40. Also, in the unit putting plastic material 40 in a closed space filled with an inert gas, the oxygen concentrations can be achieved by completely replacing air in the space with the inert gas.

The present invention is not limited to the embodiment described in the above. Various modifications are available without departing from the spirit of the present invention.

What is claimed is:

1. A plastic molding method, comprising steps of:
heating a plastic material with irradiation of one of infrared laser and focused infrared to the plastic material put in a cavity of a molding die; and
compressing the plastic material within the cavity in order to deforming the plastic material into a given shape.

2. The plastic molding method according to claim 1,
wherein the plastic material is a material where an infrared absorption material is added to a transparent material to visible light.

3. The plastic molding method according to claim 1,
wherein the infrared laser is irradiated using a carbon dioxide gas laser unit.

4. The plastic molding method according to claim 1,
wherein a water content of the plastic material is no more than 0.01% by mass.

5. The plastic molding method according to claim 2,
wherein a water content of the plastic material is no more than 0.01% by mass.

6. The plastic molding method according to claim 3,
wherein a water content of the plastic material is no more than 0.01% by mass.

7. The plastic molding method according to claim 1,
wherein a water content of the plastic material is reduced to no more than 0.01% by mass in advance before heating the plastic material.

8. The plastic molding method according to claim 2,
wherein a water content of the plastic material is reduced to no more than 0.01% by mass in advance before heating the plastic material.

9. The plastic molding method according to claim 3,
wherein a water content of the plastic material is reduced to no more than 0.01% by mass in advance before heating the plastic material.

10. The plastic molding method according to claim 1,
wherein the irradiation of one of the infrared laser and the focused infrared to the plastic material is implemented under an inert gas atmosphere.

11. The plastic molding method according to claim 10,
wherein the inert gas atmosphere comprises any one of inert gases of carbon dioxide, nitrogen, argon, and helium; and a combination of the inert gases.

12. The plastic molding method according to claim 10,
wherein a concentration of oxygen within the inert gas atmosphere is no more than 10% by mass.

13. The plastic molding method according to claim 1,
wherein the plastic material is any one selected from polycarbonate, polyester, cyclopolyolefin, acryl, alicyclic acryl resin, and olefin-maleimide-alternating-copolymer.

14. The plastic molding method according to claim 1,
wherein the plastic material is any one of a transparent material to visible light selected from polycarbonate, polyester, cyclopolyolefin, acryl, alicyclic acryl resin, and olefin-maleimide-alternating-copolymer, and
wherein an infrared absorption material is added to the transparent material.

15. The plastic molding method according to claim 1,
wherein one of a halogen lamp and a carbon heater is used as a light source of the focused infrared, and
wherein the focused infrared is focused with one of a reflection mirror and a reflection lens.

16. The plastic molding method according to claim 3,
wherein laser radiated from a light source of the carbon dioxide gas laser unit is transmitted through a hollow fiber.

17. The plastic molding method according to claim 1,
wherein the infrared laser is irradiated to an area of 5 mm to 10 mm in diameter on a surface of the plastic material.

18. The plastic molding method according to claim 1,
wherein the infrared laser is irradiated to an area of 5 mm to 10 mm in diameter on a surface of the plastic material through focusing by one of a reflection mirror and a reflection lens.

19. A plastic lens manufactured with the plastic molding method according to claim 1.

20. A camera equipped with a plastic lens which is manufactured with the plastic molding method according to claim 1.
